(19) United States
(12) Patent Application Publication
(10) Pub. No.: US 2018/0006724 A1
(43) Pub. Date: Jan. 4, 2018

(54) MULTI-TRANSMITTER VLC POSITIONING SYSTEM FOR ROLLING-SHUTTER RECEIVERS

(71) Applicant: BASIC6 INC., Westport, CT (US)

(72) Inventors: Magnus WENNEMYR, Amherst, MA (US); Tomihisa WELSH, Raleigh, NC (US)

(21) Appl. No.: 15/639,796

(22) Filed: Jun. 30, 2017

Related U.S. Application Data
(60) Provisional application No. 62/357,181, filed on Jun. 30, 2016.

(51) Int. Cl. H04B 10/116; H04W 4/02

(52) U.S. Cl. CPC H04B 10/116; H04W 4/02; H04M 2250/12; H04M 2250/52

(57) ABSTRACT

A system and a method in which the location of a receiver with a rolling-shutter based camera, typically on a mobile device, is determined with respect to the known positions of one or multiple VLC emitting sources. The positioning information can be used in the context of an encompassing system that leverages the precise position of the receiver to serve contextual information to an application on the mobile device acquired from a remote system. The method of analyzing acquired data is also disclosed. The data can be digitally encoded in base 3, wherein a duty cycle of eighty percent on and twenty percent off maintains a constant brightness, and each digit divides an on portion into two pulses of different lengths. A computer readable non-transitory storage medium storing instructions of a computer program, which when executed by a computer system results in performance of steps of the methods.

This application claims priority from and the benefit of provisional patent application Ser. No. 62/357,181 filed on Jun. 30, 2016, the entire contents of which, is incorporated herein by reference, for all purposes.

### BACKGROUND OF THE DISCLOSURE

### 1. Field of the Disclosure

The present disclosure relates to a system and method for determining the position of camera. More particularly, it relates to determining the position of a rolling-shutter camera, such as one on a mobile device, in the presence of one or more VLC emitters.

### 2. Description of the Related Art

Existing devices, such as for example smartphones, employ CMOS cameras that scan in one instant a single row of data that can be combined with data from hundreds or thousands of additional rows to form a single complete image. This fact can be leveraged to retrieve signals emitted by slightly modified commercial LED luminaires used to illuminate a scene.

There is a need for systems and methods for analyzing and processing such data to produce other useful data. In particular there is a need for systems and methods that can be used to determine the location of such devices based on the position of the camera.

### SUMMARY OF THE DISCLOSURE

In general, an embodiment of the disclosure is directed to a system in which the location of a receiver with a rolling-shutter based camera, typically on a mobile device, is determined with respect to the known positions of one or multiple VLC emitting sources. The positioning information can be used in the context of an encompassing system that leverages the precise position of the receiver to serve contextual information to an application on the mobile device acquired from a local or remote system.

The signals can be received at rates related to the frequency of individual image capture and the number of rows that combine into a single image. LED-based luminaires are modified to modulate the light emissions with on-off keying at rates imperceptible to human observers and at rates roughly commensurate with the single-row scanning so that bands of light and dark are imprinted on an image. Multiple images extracted from video can be leveraged to combine information from one image to the next to form longer strands of information than can be extracted from a single image.

Methods and systems for analyzing and processing the signals are also disclosed.

The disclosure is also directed to a method for encoding data as a base 3 digital signal, wherein a duty cycle of eighty percent on and twenty percent off maintains a constant brightness, and each digit divides an on portion into two pulses of different lengths.

Other aspects of the invention are defined by the appended claims.

Yet another embodiment of the disclosure is directed to a computer readable non-transitory storage medium storing instructions of a computer program which when executed by a computer system results in performance of steps of the methods.

### BRIEF DESCRIPTION OF THE DRAWINGS

FIG. 1 is a diagram of system in accordance with an embodiment described herein.

FIG. 2 is a waveform diagram of a simple signal that can be used in the embodiment of FIG. 1.

FIGS. 3A, 3B, 3C and 3D are waveform diagrams of signals that can be used in the embodiment of FIG. 1, of a form with greater information density.

FIG. 4 is a waveform diagram of multiple digits of a signal consisting of the type of digits depicted in FIGS. 3A, 3B, 3C and 3D.

FIG. 5 is a block diagram of a detection system for detecting the signals described in FIGS. 2, 3A, 3B, 3C and 3D.

FIG. 6 is a flowchart of a method of operation of the tracking sub-system of FIG. 5.

FIG. 7 is a flowchart of a method of operation of the detection sub-system of FIG. 5.

FIG. 8 is an image of a sample luminaire emitting a signal fragment, showing a “halo” effect around the luminaire.

FIG. 9 is a flow chart of positioning routine used to determine the position of the receiver of light from one or more luminaires.

FIG. 10 is a diagram to aid in the understanding of the similar triangles distance calculation described herein.

A component or a feature that is common to more than one drawing is indicated with the same reference number in each of the drawings.

### DESCRIPTION OF THE EMBODIMENTS

Although the present application describes the current embodiments, patent applications that are related to this application by the assignee herein are mentioned for additional context for the disclosure herein. These patent applications are patent application Ser. Nos. 61/972,754 and 14/671,694 entitled “AN OPEN, EXTENSIBLE, SCALABLE, METHOD AND SYSTEM WHICH DELIVERS STATUS MONITORING AND SOFTWARE UPGRADES TO HETEROGENEOUS DEVICES VIA A COMMON USER INTERFACE”, provisional patent applications 62/274,619 “ADAPTER EXTENDING CAPABILITIES OF REMOTE CONTROL AND LiFi TO INSTALLATIONS OF LIGHT-EMITTING DIODE-BASED LUMINAIRES”, 62/303,914 “CONSTANT CURRENT, SELF POWERED LED DRIVER SWITCHING CIRCUITS”, 62/338,815 “REMOTE CONTROLLED LED BASED ID EMITTER” and application Ser. No. 15/599,627 entitled REMOTE CONTROLLED LED BASED ID EMITTER AND DEPLOYMENT, AND APPLICATION OF SAME TO MULTI-FACTOR AUTHENTICATION. All of these patent applications are incorporated herein by reference, in their entireties, for all purposes.

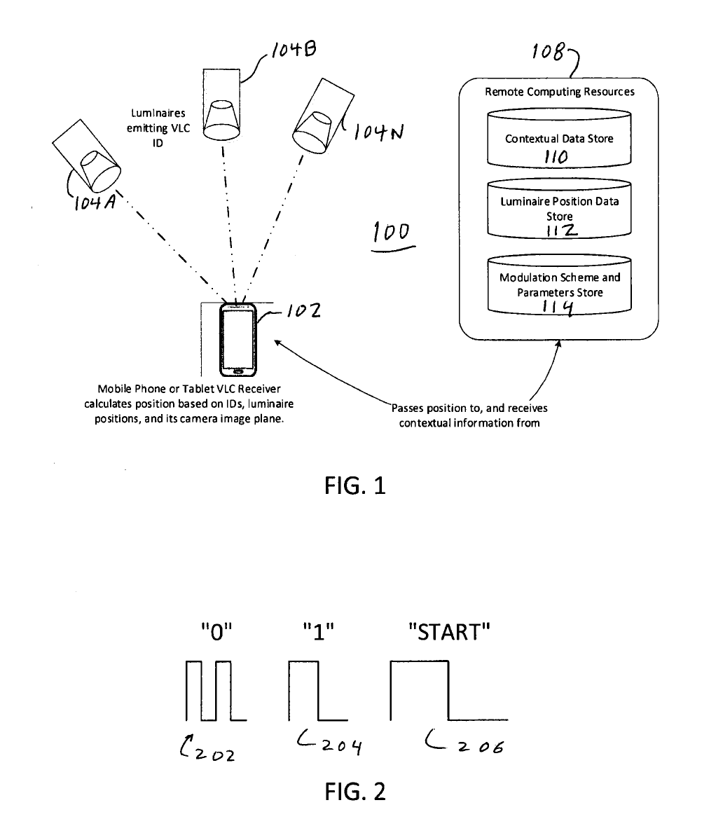

FIG. 1 is a diagram of a system 100 wherein a device, such as a mobile telephone 102, receives light from a plurality of transmitting luminaires 104A, 104B . . . 104N. It will be understood that the device may also be an iPad, tablet or any computing device having a camera, as described herein.

In the system of FIG. 1 the mobile telephone is configured to exchange data with remote computing resources 108, which includes a contextual data store 110, a luminaire position data store 112, and a modulation scheme and parameter store 114. However, it will be understood that in some embodiments, the computing resources may be local, rather than remote.

Luminaires 104A, 104B . . . 104N include circuitry driving their respective LEDs using software that modulate the light into signals of a particular format. Each luminaire 104A, 104B . . . 104N is assigned a unique identifier to emit via its modulation scheme. A rolling-shutter based camera receiver in mobile telephone 102 captures images including one or more Luminaires 104A, 104B . . . 104N. Data is acquired by mobile telephone 102 from remote or locally housed data store or stores. In general, software on the mobile telephone is used to isolate the corresponding transmitted signals in an image or set of images, to extract IDs transmitted by the luminaires 104A, 104B . . . 104N, to determine the positions of the transmitting luminaires 104A, 104B . . . 104N by accessing the database of transmitter positions to account for the position of the camera's image plane, and to calculate the position of the receiver relative to the luminaires 104A, 104B . . . 104N. Additional aspects of the receiver-resident software can include routines to remove irrelevant artifacts and to manipulate the camera exposure and other settings on an on-going basis to capture an optimal set of images. Continuous image capture and processing enables continuous position updates; in order to smooth position motion over time it is possible to integrate the position information acquired as above, with information from other sensors on the receiver such as an accelerometer.

Isolating and identifying one or more signals in such an image in a real-world situation in which noise of various types are introduced, and with a receiver in motion, to precisely identify the location of the receiver is not a trivial undertaking. The manner in which these issues are addressed, generally in software, is described below.

Generally, fixture-specific messages are identified using one of a set of known, fixed-length (fixed-duration) formats. The receiver is informed of the format that is being used via some communication channel, the description of which may be found in provisional patent application Ser. No. 62/338,815 mentioned above, but this may be from a remote repository or in the form of configuration on the receiver itself. Format variations can include data payload size (number of bits), bit representation, base pulse frequency, duty cycle, or other parameters that affect the message representation. In the approach outlined here, the signal is of fixed-length and the receiver needs information on which particular format has been selected.

In the current application, the fixture-specific messages are numeric identifiers in which the receiver can use the identifier to map the visible fixture to a known light source. The identifiers are transmitted repeatedly as a sequence of individual digits of a fixed length. Each digit is an encoding scheme using light pulses wherein the light is either ON or OFF. The specific encoding scheme for the identifiers has been derived based on a number of constraints in the system. Most importantly, the scheme was developed in order to maximize the information that can be transmitted in the shortest amount of time while still accommodating the different pixel resolution capabilities of the camera devices which are receiving the signal. Another constraint is that in any given time frame, only a fragment of the signal may be available to the receiving device. For the device to receive the full message, it must be able to receive a meaningful fragment each time frame and also be able to combine the fragments over many frames to form a complete message.

In a first, embodiment, to maintain fixed-length (fixed-duration) messages for all data payloads, “ones” and “zeroes” are represented in such a way that they are not only of the same size, but also the same average brightness. As shown in FIG. 2, zeroes are represented by two pulses 202 of a base frequency, and ones are represented by a single pulse 204 of twice the duration. The pulses for both zeroes and ones have the same duty cycle to maintain steady brightness of light outputted by the LEDs of the luminaires 104A, 104B . . . 104N.

To demarcate the start of a message, a special start “bit” or start marker 206 is needed. The start marker 206 can be a pulse lasting twice as long as a regular bit—that is, equivalent to 4 base pulses. Again, it has the same duty cycle as the zero and one pulses to maintain steady brightness.

A second embodiment represents a more efficient scheme in that more information can be transmitted in the same amount of time. The smallest transmittable unit is a “digit”. The ideal length of the digit can be determined by experimentally measuring the resolving power of various camera devices. An improved system employs a base 3 encoding scheme as it provides a good balance between information density and camera resolution. A larger numeric base (larger base) would yield more information per digit but the length of the digit would need to be longer (due to resolution constraints) and less likely to be completed in a given time frame. Note that when the receiving device is close to the light source or the light source is larger, the camera is able to observe more of the signal in a given time frame. Given likely distance ranges between the receiver and emitter, along with an expected range of luminaire size, base 3 is a good compromise experimentally. In these situations, a numeric base larger than the first embodiment of base 2 was developed in order to increase the density of information that could be transmitted per time frame.

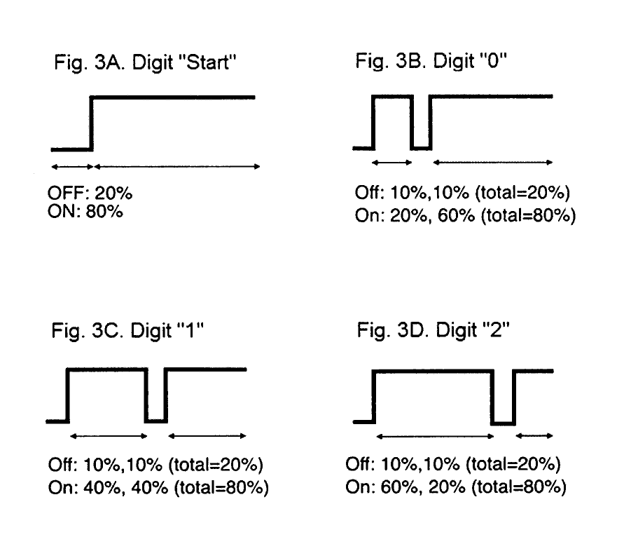

In a base 3 encoding scheme, a total of three digits (0, 1 and 2) are represented by varying a sequence of ON and OFF pulses to form a pulse pair. A duty cycle of 80% ON/20% OFF is used to maintain a constant brightness, where each digit divides the brightness into two pulses of different lengths. Because we use a fixed-length digit, an important observation is that only the length of one of the pulses is needed to determine the digit value since the length of the other pulse follows. As an example, a “0” digit is represented by a 20% pulse followed by a 60% pulse (FIG. 3B), a “1” digit by equal pulses of 40% each (FIG. 3C) and a “2” by a 60% pulse followed by a 20% pulse (FIG. 3D). Conceptually, each digit value can be thought of as a different position for the internal OFF pulse.

The message identifier is converted to a base 3 representation before being transmitted. Since the length of the message is known, decoding back to the original message is trivial by the inverse process, once each base 3 digit is successfully detected. The range of the identifier values is determined by the base and the number of digits used in the identifier. A longer message will take longer to decode, limiting the speed at which an identifier can be determined.

To demarcate the start of a message, a special start digit is transmitted (see FIG. 3A). The start marker is represented by a single pulse of 20% off followed by 80% on. It has the same duty cycle as the 0 and 1 pulses to maintain steady brightness.

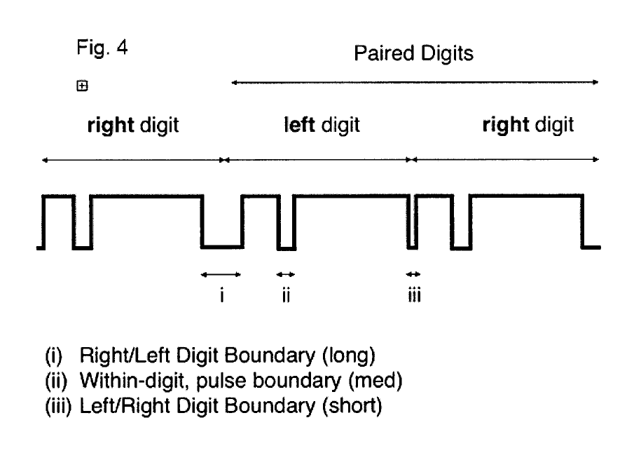

Due to the likelihood that the signal is received in a fragmented state (e.g. only a portion of the message is visible at a given moment in time), the signal can be further modified to transmit markers indicating the start of each digit. The receiving system uses the markers to determine where the start of the digit is, given only a fragment of the signal. To achieve this, digits (each of which is formed by a pair of pulses) are further paired with each other in such a way that the first digit in the pair (left in FIG. 4) begins with a longer OFF time and ends with a short OFF time, while the second digit in the pair (right in FIG. 4) starts with a short OFF time and ends with a longer OFF time. Thus, when the digits are combined for the entire message, each left-most digit is delineated by a long leading OFF time and the right-most digits are delineated by short leading OFF time. Within a digit, the pulses are separated by a medium sized OFF time. Thus, the OFF times can be differentiated by their lengths and the receiving system can use the length to determine where the digits begin and end when the message is truncated.

A further advantage of this scheme for the start digit is that mirror images of the signal will not be mistaken for valid signals.

It should be noted that the reason the digits are paired is because over a given amount of time, in order to maintain a duty cycle of 80% the number of OFF pulses presented in relation to the ON time must be limited. If the same OFF length pulse between each digit were to be employed instead of every other digit, the duty cycle would be lower. By pairing digits the amount of available OFF time is divided among two digits. A smaller OFF pulse is used to divide the pairs.

The base transmit rate is limited at the upper end by the frequency at which the camera in mobile telephone 102 is able to process each single row across the image and by the length of each bit of information. At the lower end, the frequency must be high enough that the message frequency (i.e., how often the start bit is displayed) is high enough not to be discernible or cause potential for harm to humans. This is because flickering of any type of light at low frequencies due to fluctuations in light intensity can have an effect on sufferers of photosensitive epilepsy, Meniere's disease and migraines. As known in the art, any flicker should be at frequencies above certain minimums. It is thus desirable to shorten the length of the transmission so that the start bit appears as frequently as possible. This is why the unique light IDs are best established on a per-site basis as fixtures are deployed. On the receiver end, the sampling rate must be twice as fast as the transmit rate in data transmission (so as to satisfy the Nyquist criteria); it is simple for modern electronics to keep up with this rate since the rate at which image rows are collected is relatively slow, and the ability to effectively sample the signal is therefore not a limiting factor in real-world situations. However, the camera mechanism itself imposes a limitation. The frequency must not be so high that the camera system cannot discern pattern changes and be unable to decode the signal. Video is typically processed by mobile phones at or near thirty frames per second. Another consideration is the offset between corresponding message positions in successive frames in the video feed. For each frame, the position of the message in the image is offset based on the length of the message and the transmission frequency. This offset makes it appear that the signal is moving in time and wrapping in the image. Additionally, the offset amount affects the effectiveness with which the signal can be accumulated over time. For example, if the offset is too small, and only a small fragment of the signal is available in each frame, it takes longer to accumulate the full signal. In order to optimize the speed of acquisition, the base frequency of the signal is adjusted, in combination with altering the message length. Only certain combinations of clock frequency, timer configuration, base frequency, duty cycle, and the above described pulse sizes will yield integer optical character recognition values that produce exactly the requested pulse ratios and produce alias free sampling. The values are determined empirically.

In most cases the message emitted by the LEDs of luminaires 104A, 104B . . . 104N will be long enough that it will be necessary to splice together information from a series of images from the camera of mobile telephone 102. Ideally, these will be acquired at a uniform rate, so the most obvious source is video. If the rate is not uniform and knowable, then the approach must be at least able to get the time-offset of each image relative to the previous one (that is, the offset of the acquisition start-time of two consecutive images).

In order to splice together portions of signals from one frame to the next, given an acquired image frame, its scan dimension (the direction along which the imaging sensor is read, row-by-row), and the time offset from a previous image or frame, a relative spatial offset can be computed (e.g., in number of image-row-equivalents). Any message bits extracted from one image frame can be positioned with respect to previous message bits by this means. Taking into account total message length (in image-rows), this relative spatial positioning can include wrapping so later message bits partially or completely overlap bits from previous image frames.

The effectiveness of the method may be significantly affected by scene contrast and image exposure. The ability to control exposure for image or video acquisitions can greatly improve the reliability and speed of the method. In particular, the ability to underexpose the majority of the image so that the signal-carrying fixtures and/or their near surroundings are not saturated is important. This ability may vary from receiver device to device; development of the current embodiments assumes this level of control to be present, and that degradation of interpretation of the signal may occur in other cases.

For practical reasons, the current embodiments assume that the LEDs in luminaires 104A, 104B . . . 104N are used for two purposes simultaneously, to illuminate space, and all the while emitting VLC signals. This introduces additional difficulty, especially as dimming is supported by the lights, which can deteriorate signal to noise ratios. While it is possible to alternatively construct lighting such that some LEDs are used solely for the former purpose, while others are dedicated for VLC transmission, the more complex case is described here. All else being equal, such deployment would be less expensive than double-lit spaces. The case of LEDs dedicated to VLC transmission without consideration of lighting of spaces may be considered a sub-case of the present disclosure.

Modulated signals may contain not only unique IDs of the emitters, but may carry any information relevant to the context of the application. For instance, LEDs can emit information for display on a receiving device, or can emit information concerning the type of device from which the emission in being made, for management purposes. The present disclosure requires only that some identifying ID be included in the emitted signal.

Processing Routine

During some early initialization stage, all information modulation scheme and message format information is acquired by the receiver, whether pre-loaded or from a remote repository. This can be based, for example, on the location of the receiver as detected via a GPS receiver therein or from a Bluetooth-based beacon. If transmitter deployments do not vary from site to site, the values can be included in the software installation. Additionally, characteristics of the individual camera in a receiver can be measured when the software is exercised for the first time after installation. The number of image scan rows and video frame rates are particularly important; the presence or absence of an ability of individual receivers to modify the exposure programmatically also determines whether certain related aspects of the algorithm can be included during image collection. For example, if the particular camera of some device does not permit access to controls for adjusting the exposure, then there is no way to make use of that feature. In that case it will not be possible, for example, to attempt data capture with one exposure level, and if the result is unsatisfactory, it is necessary to change the exposure level and try again. This method of acquiring the “calibration” parameters for the camera can be obtained for specific camera and phone models once, and stored on a server to be transmitted to individual instances of the application.

The calibration procedure involves running the calibration software on a camera device while recording the modulated luminaire signal as described in the previous section. The parameters obtained are used by the detection system to facilitate the decoding process. In particular, due to differences in the speed or rate that individual camera frames are captured, the length of the complete signal varies with the pixel length of the message in the image. The calibration procedure measures the length of each digit of the signal in the image frame. Other features of the camera system such as focal length and ISO capabilities (sensitivity of a camera to light as defined by International Standards Organization) are also evaluated. The basic calibration procedure determines the base length in pixels of the individual digits of the message transmitted.

The information discussed above can be used to compute the minimum number of frames needed to image a complete message for the smallest anticipated fixture size as represented within the images (if the camera is far from a fixture, it will be represent as a small feature, if it is closer, it will be a larger feature taking up more pixels).

For each frame collected as above, the immediate goal is to precisely identify the light sources in the image frame. If the light sources do not illuminate anything in the frame, they cannot be found. Further, if the light sources are not viewable in the frame, but illuminate something else in the frame (for example, a mirror), then inaccurate location data may be acquired, which, ideally, should be eliminated, as a kind of “noise”. At this point, the frame contains all likely sources, based on the assumption that they are the brightest objects in the image. Non-emitter bright lights dirty the segmentation process, and are filtered out only in later stages that no signal is identified as emanating from them.

The Detection System

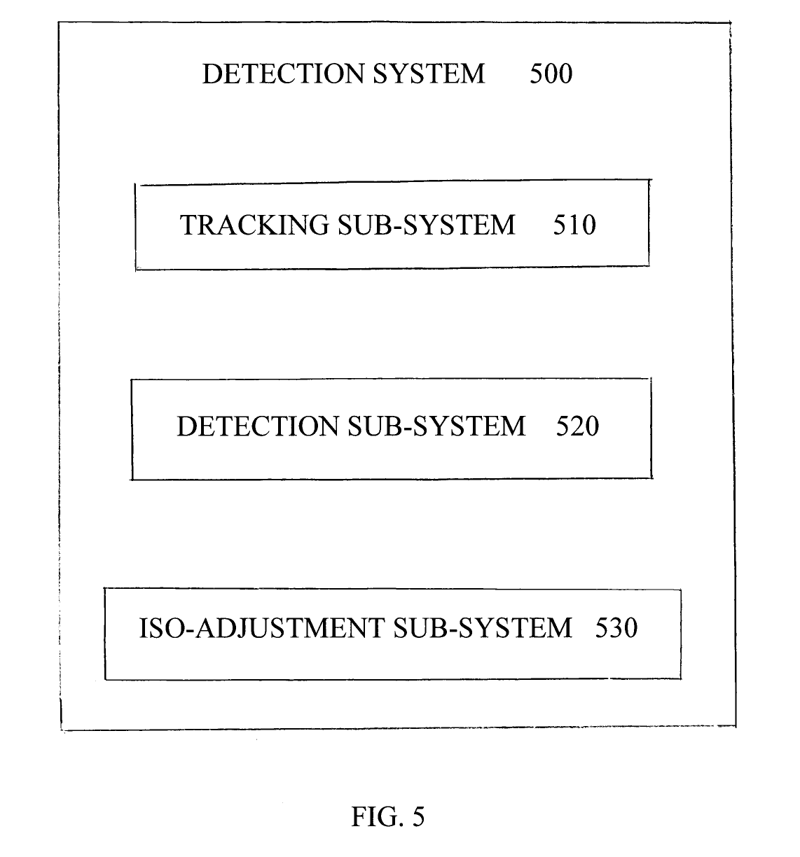

Referring to FIG. 5, a detection system 500, which can be implemented by software or an “App” on a device, such as a mobile telephone 102 (FIG. 1) consists of three sub-systems working together to determine the identifier of the luminaires and to track the whereabouts of the receiving device relative to the luminaires. The sub-systems are a tracking sub-system 510, a detection sub-system 520 and an ISO-adjustment sub-system 530. The tracking sub-system 510 enables information for individual luminaire devices to be obtained over the course of many temporally connected frames of the camera or video feed. Tracking is necessary because the full message is typically not available in a single time frame and must be combined using the results of many frames. Further, once a luminaire identifier is known, the detection system uses the tracking sub-system to determine luminaire position without having to reprocess the luminaire for the identifier. The detection sub-system 520 works independently from tracking. This sub-system is fed individual image frames for each separate potential luminaire. The detection sub-system 520 combines the frames over time to decode the message and identify the luminaire. Finally the ISO-adjustment sub-system 530 is used to adapt the current ISO setting to the changing lighting conditions to maximize the ability of the application to detect luminaires.

The Tracking Sub-System

The tracking sub-system 510 processes individual camera frames to identify multiple potential luminaires in the scene. It is also responsible for determining over multiple frames whether the current luminaires match previously tracked luminaires. For the present discussion these luminaires may or may not be known, identifiable luminaires. The tracking sub-system 510 works independently from the decoding subsystem and simply tracks potential luminaire objects while the detection system will later reject non-identifiable luminaire objects.

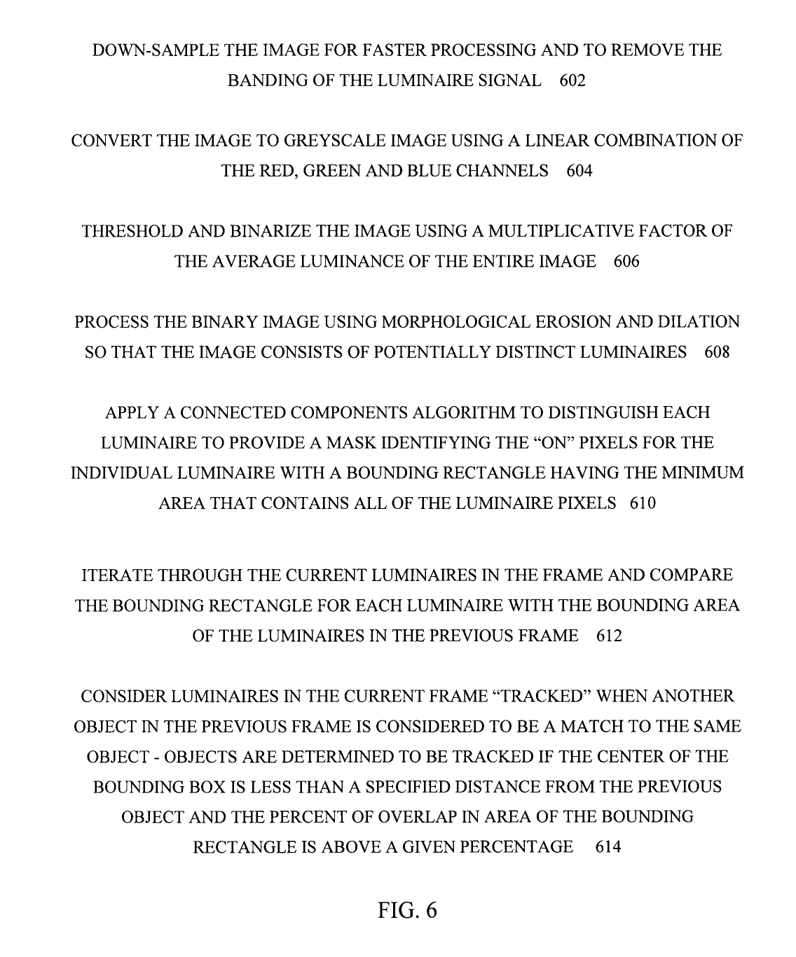

Referring to FIG. 6, for each image frame, the tracking sub-system 510 applies several standard image processing techniques to the entire image. (1) At 602, the image is down-sampled by, for example, a factor of 4 to allow faster processing and to help remove the banding of the luminaire signal. (2) At 604, the image is converted to a greyscale image using a linear combination of the red, green and blue channels. (3) At 606, the image is thresholded and binarized (e.g. each pixel represented by a 0 or 1 value) using a multiplicative factor of the average luminance of the entire image. (4) At 608, the binary image is then processed using morphological erosion followed by dilation, employing a square structural element. This procedure removes the individual light bands of the modulated signal so that the object is fully connected. At this point, the image consists of potentially distinct luminaires. In order to distinguish the individual luminaires and allow tracking, a standard connected components algorithm is applied, at 610, to distinguish each luminaire. The result of the connected components algorithm is a mask identifying the “on” pixels for the individual luminaire. The mask's bounding rectangle is constructed to be the minimum area that contains all of the luminaire pixels.

The procedure of tracking the luminaires continues at 612 by iterating through the current luminaires in the frame and comparing the bounding rectangle for each luminaire with the bounding area of the luminaires in the previous frame. Luminaires in the current frame are considered “tracked” when another object in the previous frame is thought to be a match to the same object. At 614, objects are determined to be tracked if the center of the bounding box is less than a specified distance from the previous object and the percent of overlap in area of the bounding rectangle is above a given percentage.

The Detection Sub-System

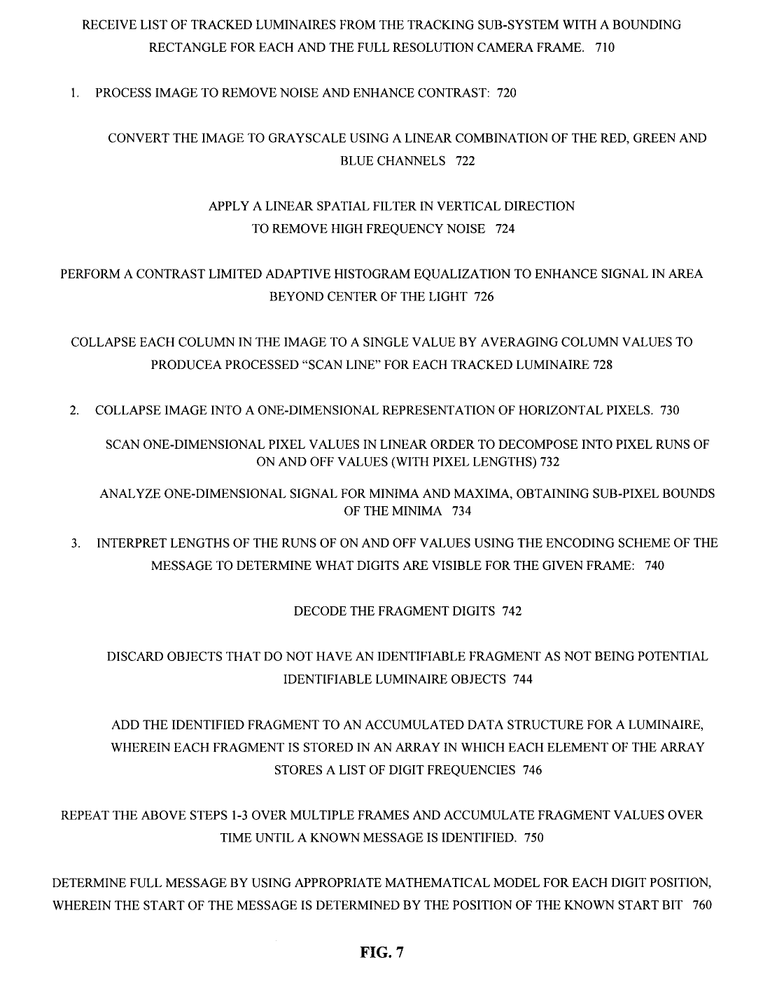

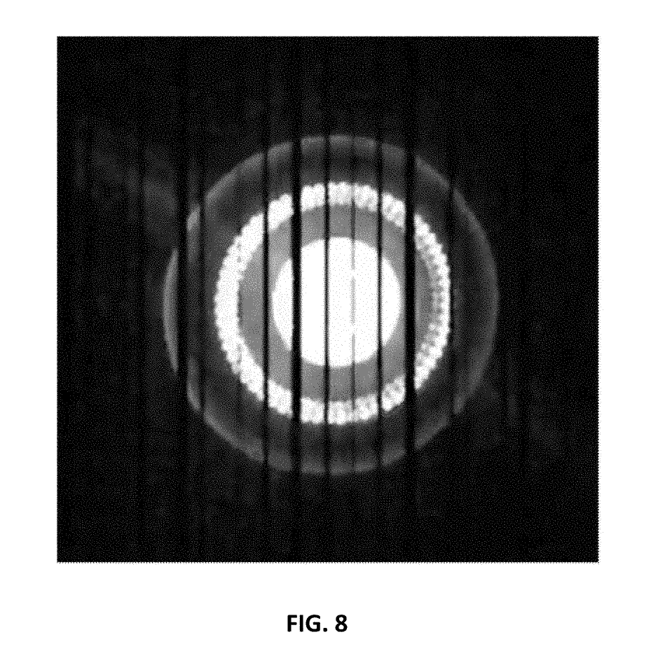

Referring to FIG. 7, in general, the detection sub-system 520 determines whether a “potential” luminaire is actually a known, identifiable luminaire. At 710, as input, the system receives the list of tracked luminaires from the tracking sub-system with a bounding rectangle for each and the full resolution camera frame. For a given frame in time, the detection step performs three basic operations. (1) At 720, the image is processed to remove noise and enhance contrast before being collapsed into a one-dimensional representation of horizontal pixels. (2) At 730, the one-dimensional pixel values are scanned in linear order to decompose the one-dimensional pixels into pixel runs of ON and OFF values (with pixel lengths). (3) At 740, the length of the runs of ON and OFF values are interpreted using the encoding scheme of the message (VLC ID) to determine what digits are visible for the given frame. Since the message fragment may not contain the full message (depending on the scene and light hardware characteristics), at 750, the detection sub-system 520 normally must repeat the above steps over multiple frames and accumulate fragment values over time. This operation of the detection sub-system 520 continues until a known message is identified. The detection sub-system 520 engages in a number of sequential steps that are each further discussed in detail below.

As noted above, at 720, the first step executed in the detection system is to process the two-dimensional image for the given, tracked luminaire. The VLC ID signal results in banding (brightness variations) parallel to the “rows” of the image (the long axis of the device). The actual brightness of ON and OFF parts of the signal, however, in a real-world situation, vary widely across the image (and even across one segment) due to a variety of factors that are all considered signal noise. In this regard, see FIG. 8 for a sample luminaire emitting a signal fragment. The full resolution image is required to obtain sufficient accuracy in decoding the signal. The goal of the image processing step is to convert the image into a single horizontal scan line in which low pixel values (0) represent the OFF portion of the signal pulse, and maximum (255) values represent the ON portion of the light pulse. The following pre-processing steps occur on the full resolution sub-image which is bounded by the tracked mask area. (1) At 722, the image is converted to grayscale using a linear combination of the red, green and blue channels. (2) At 724, a box blur (e.g. a linear spatial filter) is applied in the vertical direction in order to remove high frequency noise but not affect the signal pattern which only occurs along the horizontal axis. (3) At 726, Contrast Limited Adaptive Histogram Equalization is performed if necessary to enhance the signal in the area beyond the center of the light. A certain “halo” or light glow may extend beyond the shape of the light fixture, and performing an additional contrast enhancement is useful for extending the size of the signal fragment into this “halo”. (4) At 728, each column in the image is collapsed to a single value by averaging column values. The final result is a processed “scan line” for each tracked luminaire which is ready for one-dimensional signal processing.

At 732, the detection sub-system 520 decomposes the one-dimensional signal into “runs” in which a run represents either an ON or OFF pulse of the signal and a length in pixels for the run. At 734, the one-dimensional signal is analyzed for minima and maxima using, for example, a published algorithm entitled Persistence1D algorithm (https://people.mpi-infmpg.de/˜weinkauf/notes/persistence1d.html). By locating the minima/maxima, we are able to determine the locations of the ON and OFF pulses despite variability in the signal quality. This is necessary because the dark OFF bands frequently vary in their levels and simple thresholding is less accurate. Once the minima are roughly identified, the system scans left and right until a given threshold is met to find the bounds of the minima. In order to obtain sub-pixel accuracy the index cutoff positions are interpolated into floating point positions by modeling the edge as a rectangle section (see the Fitzgibbon et al. reference below). It is sufficient for the sub-system to only store minima location and strength values for further calculations since the ON pulses can be deduced from the location and strength of the OFF pulses.

The third step for execution in the detection sub-system is to interpret or decode, at 740, the fragment digits, and is somewhat specific to the exact signal representation being used. Multiple ways of encoding the signal may be supported; however a basic premise for all is that the positions and lengths of the OFF pulses in pixels are known for the frame. Also, given camera calibration, the length in pixels of a fixed length digit in the signal is known for the given camera system. Combining these, the final subsystem converts the positions of the OFF pulses into a message fragment. The rules of the encoding system can be applied by scanning the distances of pulses and also their length. As described previously, the length of the OFF pulses is an indication that distinguishes the start of a digit from the middle or from the beginning of the message. For this step the pixel position of the start of the fragment is recorded. This is necessary to later mark where in the message the fragment aligns.

Finally, at this point, a fragment and pixel offset is known for a single time frame for each potential luminaire. The detection sub-system 520 will discard any objects that do not have an identifiable fragment as not being potential identifiable luminaire objects. At 746, if a fragment was identified, it can be added to the “accumulator” data structure for that luminaire. The accumulator is responsible for storing the fragment values for the fragment at a given offset. The very first fragment recorded begins at offset 0, and subsequent offsets are determined by the pixel offset relationship combined with the offset in time as determined by frame rate. The reason for this pixel offset relation is that the actual pixel values are representations of the signal in time due to the rolling shutter sampling method. Therefore a pixel offset in space corresponds to a time offset in the signal. Each fragment is stored in an array (the size is the message length) in which each element of the array stores a list of digit frequencies. At 760, when enough digits are accumulated over time, the full message can be determined by using the mathematical model for each digit position. The start of the message is determined by the position of the known start bit.

The ISO-Adjustment Sub-System

The ISO-adjustment sub-system 530 is responsible for detecting when scene illumination is either too bright or too dark and adjusting ISO accordingly. The system measures noise and the amount of light in the image frame to lower the camera ISO (sensitivity) if either becomes large or to increase it to maintain a baseline level. The reason for maintaining a moderate ISO is two-fold. First, if the camera light sensitivity becomes too large, a large “halo” forms around the light in some situations (see FIG. 8); this is also affected by increased night sensitivity on certain cameras. Although the “halo” provides additional signal information, it also negatively affects precision of the calculation for the size of light. Secondly, very high ISO levels introduce noise into the image which affects the accuracy of the system to accurately detect the signal bands (ON/OFF pulses). By adjusting the ISO, the system is able to maintain consistent noise levels which is one approach to normalizing the signal quality between different camera types.

In order to calculate noise levels in the image frame, the system calculates the standard deviation for a small, fixed window size of pixels. The total noise is determined by averaging samples in the image over in a coarse grid to minimize the processing time. The total light level is calculated as the percent of pixels of the mask to the area of the mask. The ISO is lowered if a linear combination of noise and total light levels is above a certain threshold or increased if below a certain threshold.

Positioning Routine

Once one or more fixtures have been identified, the luminaire position data store is leveraged for acquiring the three-dimensional positions of the signal emitters, thus identifying an approximation of the location of the receiver. Options for determining positioning based on the signals determined by the processing routine depend on the number of emitters detected in a single frame.

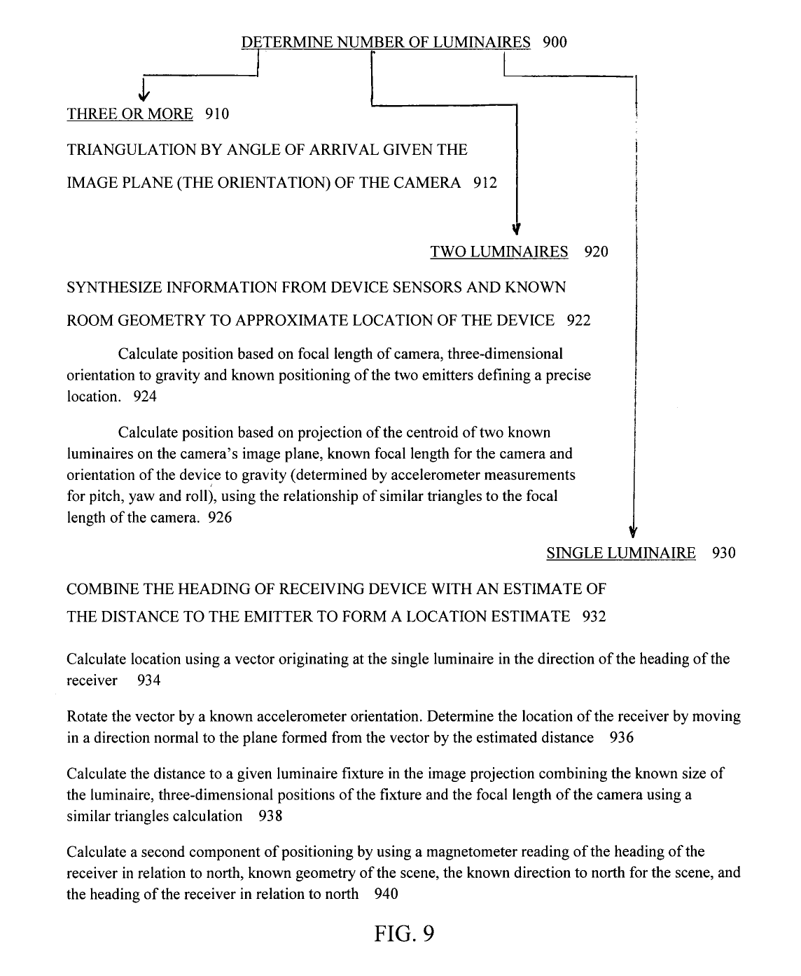

Referring to FIG. 9, the steps used to determine the position of the receiver of light from a luminaire will depend on the number of luminaires in the field of view of the receiver or camera. If there are three of more luminaires in the field of view, then processing is done as at 910. If there are two luminaires in the field of view, then processing is done as in 920. If there is one luminaire in the field of view, then processing is done as in 930.

Where three or more emitters are identified in a single frame, at 912, triangulation by angle of arrival is used by well-known means to calculate the receiver location with greater precision, given the image plane (the device orientation) of the camera.

Depending on the number of lights, their size, density (distance between lights) and positions it is likely that at any given moment less than three lights will be visible at a time.

When fewer than three emitters are visible in a given time frame, the system can synthesize information from device sensors and known room geometry to form a close approximation to the correct location of the device, as at 922.

In the case of two visible emitters, as at 924, the camera's focal length and three-dimensional orientation to gravity can be used with the known geometry of the two emitters to form a precise location. Given the projection of the centroid of two known luminaires on the camera's image plane, a known focal length for the camera and the orientation of the device to gravity (determined by accelerometer measurements), the exact position of the camera can be determined within the parameters of the sensors, using the centroid of the bounding boxes of the lights, as at 926. This geometric calculation follows by mapping the vector from Light A to Light B in real world coordinates to the projected vector in the image plane and using the relationship of similar triangles to the focal length of the camera. The accelerometer values for pitch, yaw and roll available as inherent capabilities of the phone form a rotation matrix that adjusts for orientation.

In the case of a single visible emitter, at 932, the receiver device's heading from its magnetometer can be combined with an estimate of the distance to the emitter to form a location estimate with precision depending on the accuracy of the distance and heading calculation. At 934, the location estimate is calculated by originating a vector at the single light in the direction of the device's heading and then rotating the vector by the known accelerometer orientation as 936. Given the adjusted direction, the device's location can be determined by moving in a direction normal to the plane formed from the vector by the estimated distance. The accuracy of this calculation largely depends on the distance calculation which is described below.

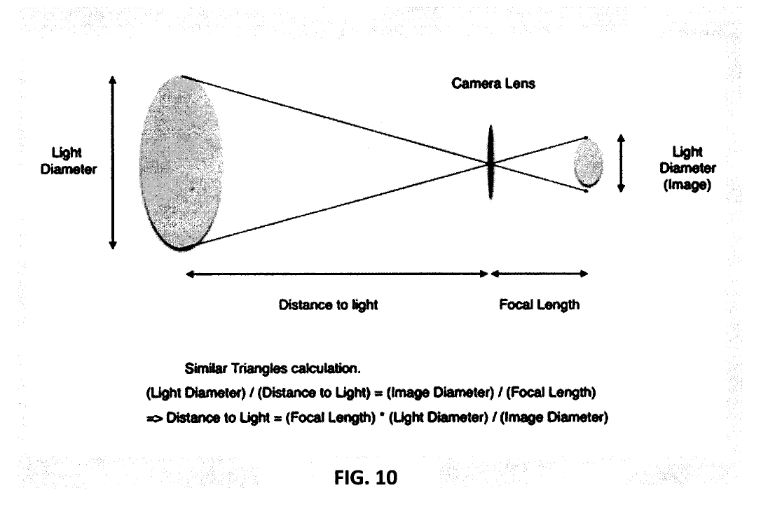

Positioning using a single light source largely depends on the accuracy of the distance measurement. The observed size of a luminaire fixture in the image projection, combined with the known focal length of the camera, can be used to calculate the distance to a given fixture from the device, given contextual knowledge of the physical size and mounted three-dimensional positions of each fixture, as at 938. The distance is determined based on a well-known similar triangles calculation (FIG. 10). The calculation relies on having measured dimensions for the fixture and matching the observed image feature with the known object geometry. In the case of circular shaped lights, the radius of the light is determined in image coordinates by fitting the shape of an ellipse to observed pixels. In the case of a rectangular fixture, the corners of the object are determined using standard corner detection algorithms, thus revealing the geometry of the observed quadrilateral. Since the binarized mask for each luminaire has already been obtained from the tracking sub-system, that image can be used for each calculation.

At 940, a second component of positioning when using a single light source is the orientation of the device in relation to the scene. This is largely determined by the magnetometer reading which can be used to find the heading of the device in relation to north. Given the known geometry of the scene, the known direction to north for the scene, and the heading of the device in relation to north, the direction in which the device lies in relation to the light can clearly be determined.

Generally, for any number of detected emitters, in the case where the device does not have a magnetometer or in which there is interference (common in indoor environments), orientation may be estimated by combining a single accurate heading with the gyroscope sensor. This forms the basis for a fallback mechanism in many situations. For instance, when two lights are visible at the same moment but later only one of these are visible, there is enough information to determine the precise heading of the device by observing the vector pointing between the two lights, in the image plane. Subsequently gyroscopic rotation measurements may be used to deduce the heading based on the initial, accurate measurement. At any given moment, if the two lights are visible again, the system is able to re-initialize the gyroscopic changes to avoid errors due to drift. This turns out to be an effective means for calculating location estimates in realistic settings.

A loop of the above steps can be used to continuously track fixtures as they come and go from view, or when a new acquisition cycle is commenced. In order to smooth out fluctuations in the measurements, a Kalman filter is used. To increase the calculation efficiency, three one-dimensional Kalman filters are employed; one for each position component (x, y, z).

From one calculated position to the next over time as acquired by the above algorithm, the motion of the receiver is deduced. It is, however, possible to further constrain the likely next position based on the previous known locations and by incorporating the use of other sensors, as described below.

Further position constraint can be accomplished by integrating motion sensor information, such as from an accelerometer, from the receiver when available, to correlate previous known positions against the next calculated position. This is accomplished by averaging the position calculated as above with motion predicted by the motion sensor. Further, the motion information from the accelerometer is combined with the pedometer sensor to determine if it is likely that the device moved. This is useful when the device goes from a state where location accuracy is high (e.g. more than two lights are visible) to a state in which only one light (or none) is visible. In this case, the location can determined to be fixed to a known value in the absence of movement.

With respect to FIG. 10, reference is made to Andrew W. Fitzgibbon, R. B. Fisher. A Buyer's Guide to Conic Fitting. Proc. 5th British Machine Vision Conference, Birmingham, pp. 513-522, 1995, as mentioned above. The technique used for ellipse fitting is the first one described in this summary paper.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for determining a position of a rolling shutter receiver, comprising:
a camera including the rolling shutter receiver, the camera being positioned to receive light from at least one luminaire wherein each luminaire provides data including at least one of a unique identifier and a unique location of the luminaire in a given venue;
a communications channel for communicating the data from the camera to a computing resource; and
the computing resource having components for processing the data to derive from the data a position of the rolling shutter receiver at the venue.

2. The system of claim 1, wherein the computing resource comprises:
a contextual data store;
a luminaire position data store; and
a modulation scheme and parameters data store.

3. The system of claim 2, wherein the computing resources comprise components for isolating signals from the luminaires in an image or in a set of images from the camera.

4. The system of claim 3, wherein the computing resources further comprise components for extracting the identifiers and determining the position of the image plane of the camera based on the identifiers.

5. The system of claim 4, wherein the computing resources further comprise components for calculating a position of the receiver relative to the luminaires.

6. The system of claim 4, further comprising:
at least one sensor associated with the receiver for providing sensor-based position data of the receiver, wherein the computing resources further comprise components for integrating the sensor-based position data with the calculated positions of the receiver.

7. The system of claim 1, wherein the data is provided as a base 3 digital signal, wherein a duty cycle of eighty percent on and twenty percent off maintains a constant brightness, and each digit divides an on portion into two pulses of different lengths.

8. The system of claim 1, wherein the camera includes a detection system having a tracking sub-system for tracking the at least one luminaire, a detection sub-system for decoding the data to identify the luminaire and an ISO-adjustment sub-system to adapt current ISO setting to changing lighting conditions.

9. A method for determining a position of a rolling shutter receiver, comprising:
positioning a camera including the rolling shutter receiver to receive light from at least one luminaire wherein each luminaire provides data including at least one of a unique identifier and a unique location of the luminaire in a given venue;
communicating the data from the camera to a computing resource; and
using components of the computing resource to process the data to derive from the data a position of the rolling shutter receiver at the venue.

10. The method of claim 9, further comprising using the computing resources for isolating signals from the luminaires in an image or in a set of images from the camera.

11. The method of claim 9, further comprising using the computer resources for extracting the identifiers and determining the position of the image plane of the camera based on the identifiers.

12. The method of claim 11, further comprising using the computer resources to calculate position of the receiver relative to the luminaires.

13. The method of claim 11, wherein the receiver further comprise at least one sensor associated with the receiver for providing sensor-based position data of the receiver, wherein the method further comprises integrating the sensor-based position data with the calculated positions of the receiver.

14. The method of claim 9, wherein the data is processed by steps comprising:
tracking an image of at least one luminaire,
decoding the data associated with the luminaire to identify the luminaire; and
adjusting an ISO setting in response to changing lighting conditions.

15. The method of claim 14, wherein the tracking comprises:
down-sampling images from the camera;
convert the images to greyscale images;
thresholding and binarizing the images using a multiplicative factor of the average luminance of an entire image;
process the binary image using morphological erosion and dilation employing square structural elements;
applying a connected components algorithm to distinguish each luminaire to provide a mask identifying pixels that are on for each luminaire, with a bounding rectangle having the minimum area that contains all of the luminaire pixels;
iterating through the luminaires in a frame;
compare the bounding rectangle for each luminaire with the bounding area of the luminaires in a previous frame;
considering luminaires in a current frame tracked when a center of the bounding box is less than a specified distance from the previous center and a percent of overlap in area of the bounding rectangles is above a given percentage.

16. The method of claim 14, wherein the decoding comprises steps of:
a. receiving list of tracked luminaires from the tracking sub-system with a bounding rectangle for each and a full resolution camera frame;
b. processing images to remove noise and enhance contrast;
c. collapse image into a one-dimensional representation of horizontal pixels;
d. interpreting lengths of runs of on and off values using the encoding scheme of the data to determine what digits are visible for the frame;
e. decoding digits of fragments of the data;
f. discarding objects that do not have an identifiable fragment as not being potential identifiable luminaire objects;
g. adding the identified fragment to an accumulated data structure for a luminaire, wherein each fragment is stored in an array in which each element of the array stores a list of digit frequencies;
h. repeating steps a. through g. over multiple image frames until a known image is identified; and
i. using an appropriate mathematical model for each digit position, wherein a message start is determined by a position of a known start bit.

17. The method of claim 9, wherein the data is provided as a base 3 digital signal, wherein a duty cycle of eighty percent on and twenty percent off maintains a constant brightness, and each digit divides an on portion into two pulses of different lengths.

18. The method of claim 9, wherein the position of the receiver is determined by steps of:
triangulation when there are three or more luminaires in an image frame of the camera;
synthesizing information from sensors and known venue geometry when there are two luminaires in the image frame; and
combining a heading of the receiving device with a distance to the luminaire when there is one luminaire in the image frame.

19. A computer readable non-transitory storage medium storing instructions of a computer program which when executed by a computer system results in performance of steps of the method of claim 9, by the additional steps of:
receiving the data from the camera; and
processing the data to derive from the data a position of the rolling shutter receiver at a venue.

20. A method for encoding data as a base 3 digital signal, wherein a duty cycle of eighty percent on and twenty percent off maintains a constant brightness, and each digit divides an on portion into two pulses of different lengths.

21. The method of claim 20, wherein the digital signal is used to modulate a light source to carry data indicating the identity of the light source.
